(19) United States
(12) Patent Application Publication
(10) Pub. No.: US 2025/0111735 A1
(43) Pub. Date: Apr. 3, 2025

(54) GAMING SYSTEM AND METHOD WITH A MULTI-LEVEL FEATURE

(71) Applicant: LNW Gaming, Inc., Las Vegas, NV (US)

(72) Inventors: Ted HASE, Las Vegas, NV (US); Kyle LEIBOVITZ, Henderson, NV (US); Joshua SIEVERDING, Henderson, NV (US); Yanis TSOMBANIDIS, Las Vegas, NV (US); Emily WASIELEWSKI, Las Vegas, NV (US); Hong WEI, Henderson, NV (US)

(21) Appl. No.: 18/904,120

(22) Filed: Oct. 2, 2024

Related U.S. Application Data
(60) Provisional application No. 63/587,581, filed on Oct. 3, 2023.

(51) Int. Cl. G07F 17/32

(52) U.S. Cl. CPC G07F 17/3213; G07F 17/3258

(57) ABSTRACT

There are provided a gaming machine and method that utilize game-logic circuitry and a presentation assembly configured to present a plurality of symbol-bearing base reels and a base array. The plurality of base reels are repeatedly spun and stopped to land symbols from the base reels in the base array. In response to the landed symbols including a triggering symbol combination, a level up mode recursively adds additional pluralities of symbol bearing reels and arrays for each subsequent triggering symbol combination prior to exhaustion of a spin counter. The symbols forming each triggering combination are at least partially removed from the reels and replaced with replacement symbols including enhanced payment symbols to make the game more lucrative at each level.

### CROSS-REFERENCE TO RELATED APPLICATIONS

This application claims the benefit of priority to U.S. Provisional Application No. 63/587,581, filed Oct. 3, 2023, the contents of which are hereby incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023-2024, LNW Gaming, Inc.

### FIELD OF THE INVENTION

The present invention relates to a technological improvement to gaming systems, gaming machines, and methods and, more particularly, to technological improvements in connection with a multi-level feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

There are provided a gaming machine and method that utilize game-logic circuitry and a presentation assembly configured to present a plurality of symbol-bearing base reels and a base array. The plurality of base reels are repeatedly spun and stopped to land symbols from the base reels in the base array. In response to the landed symbols including a triggering symbol combination, a level up mode recursively adds additional pluralities of symbol bearing reels and arrays for each subsequent triggering symbol combination prior to exhaustion of a spin counter. The symbols forming each triggering combination are at least partially removed from the reels and replaced with replacement symbols including enhanced payment symbols to make the game more lucrative at each level.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIG. 3 is an exemplary presentation of a base game spin outcome in accordance with one or more embodiments.

FIG. 4 is an exemplary presentation of a special game symbol in accordance with one or more embodiments.

FIG. 5, FIG. 6 and FIG. 7 are exemplary presentations of leveled-up game spin outcomes in accordance with one or more embodiments.

FIGS. 8A and 8B are a flow diagram for a data processing method that corresponds to instructions executed by a controller, according to an embodiment of the present invention. FIG. 8A relates to a base-game portion of a wagering game; FIG. 8B relates to a leveled-up portion of the wagering game.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

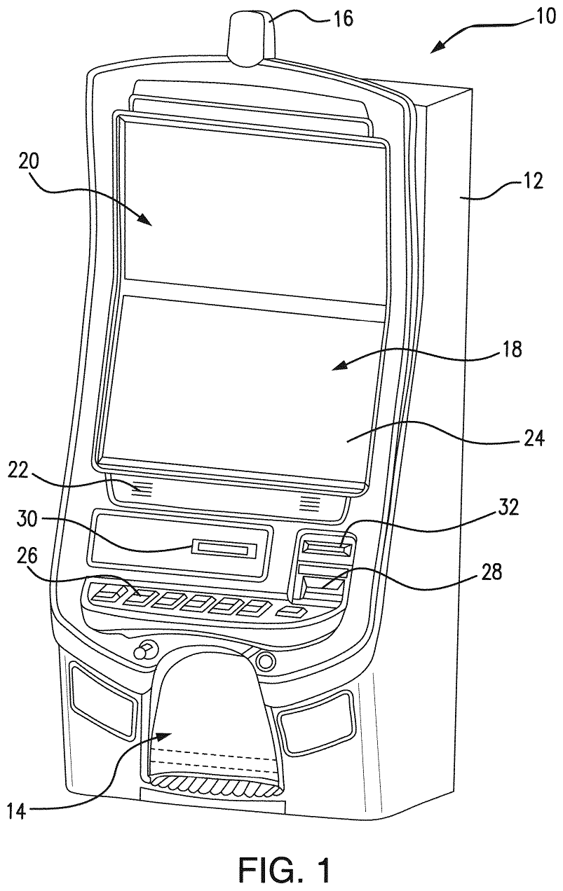

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

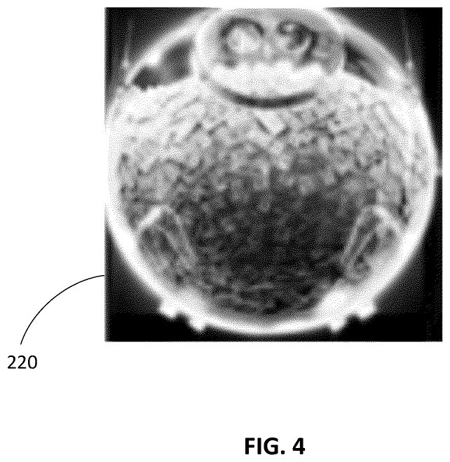

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

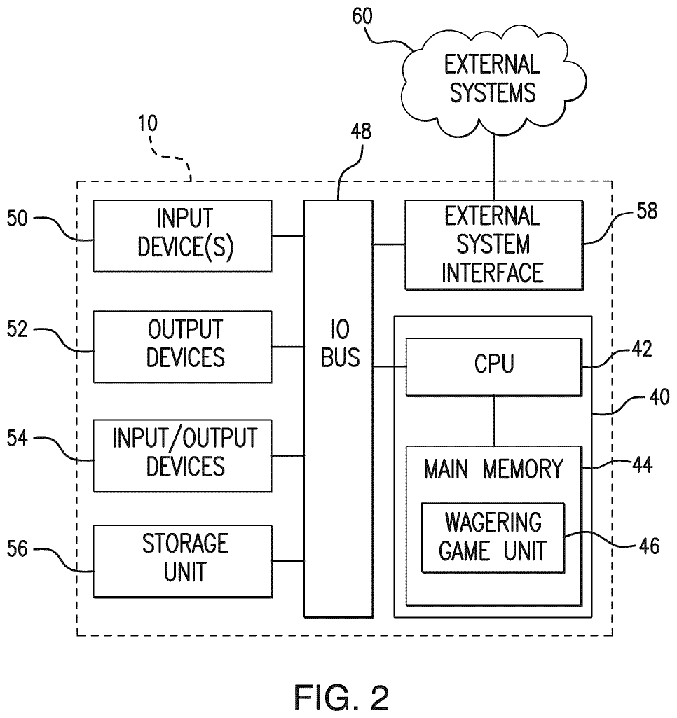

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

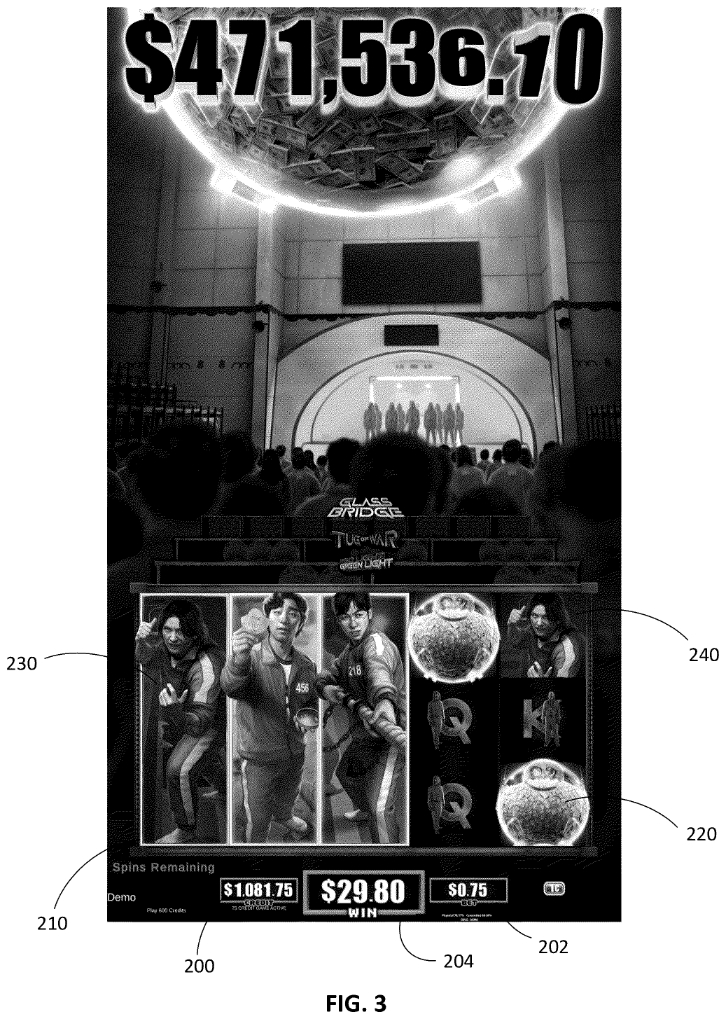

FIG. 3 represents the outcome of a representative first game spin of a base game in accordance with one or more embodiments. The game-logic circuitry, via the presentation assembly, presents a plurality of symbol-bearing base reels and a base array. In the exemplar game, the plurality of base reels are repeatedly spun and stopped to land symbols from the base reels in the base array to produce various base game outcomes.

Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual symbol positions of the array such that each reel animates in place and populates only its respective symbol position. The symbol array configuration may vary between the base game and any bonus games utilizing the array.

In FIG. 3, the symbol array 210 in the base game has a three-by-five rectangular configuration, and each symbol position is associated with a respective independent reel. The reels bear a plurality of symbols that may, for example, include various base game symbols 10, J, Q, K, A (Q and K are shown) and a special PIG symbol 220. FIG. 4 illustrates the special PIG symbol, represented as a bulging piggy bank full of money. When the same symbols appear adjacent to one another in a column, they may be represented as a single “stacked” symbol. For example, in the first column, a stacked symbol 230 indicates that three of the single character symbols 240, as seen in the third column, landed in the first column. Though shown as a stack, each location in the array is still treated individually for win evaluation purposes (described below).

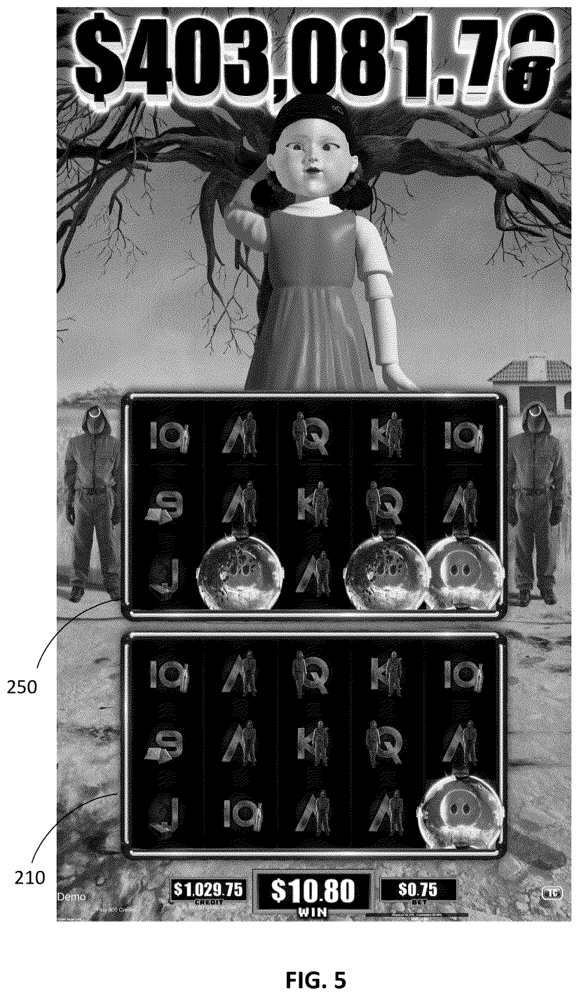

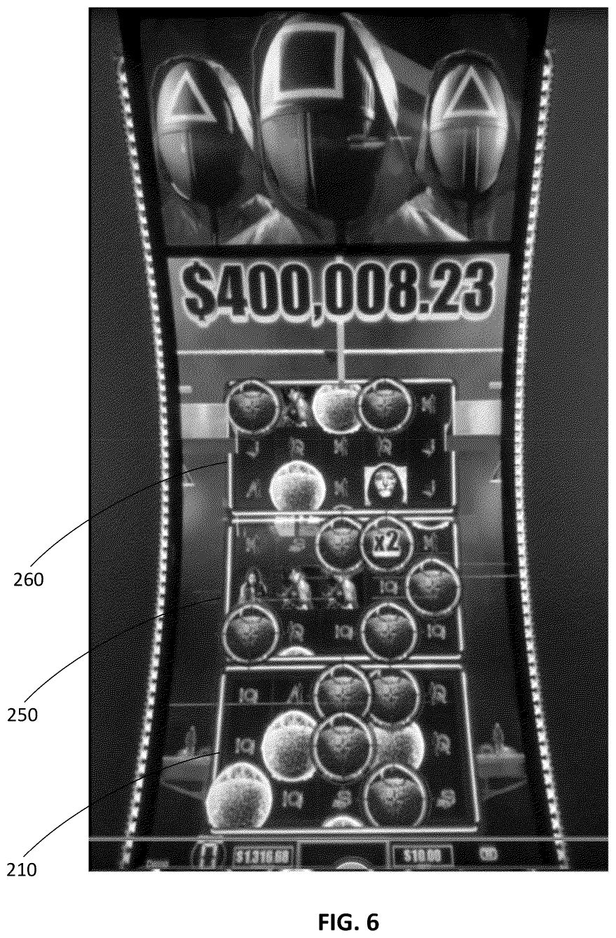

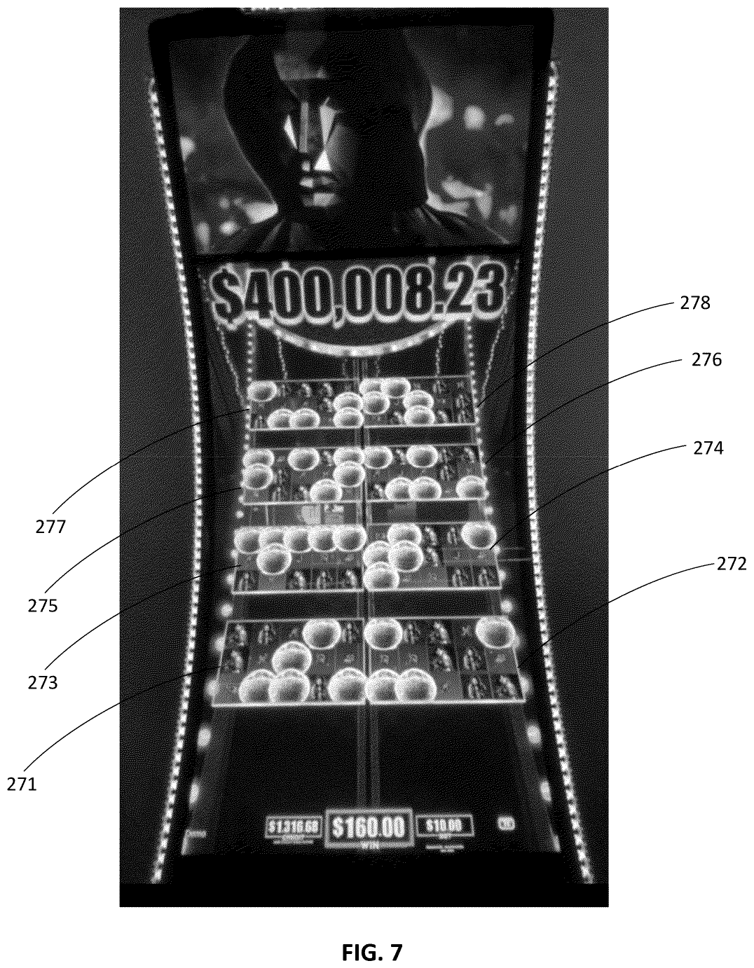

Referring to FIG. 5, in response to a first triggering symbol combination, for example, the appearance of one of the three-high stack symbols such as the stack 230 in the first column of array 210 (FIG. 3), a “level up” action to Level One is initiated, placing the game in “Level Up” mode.

At Level One, a second plurality of symbol bearing reels and second array 250 are added to the game. The symbols forming the first triggering combination are at least partially removed from the reels and replaced with a mix of symbols including enhanced payment symbols, for example, PIG symbols. In some embodiments, all occurrences on the reels of the symbols forming the first triggering combination are removed and replaced, An initial number of spins are assigned to a spin counter (not shown), for example, five spins. The pluralities of reels are repeatedly spun and stopped to land symbols in their respective arrays and the spin counter is decremented following each spin. If no spins remain, the Level Up mode is terminated and the game resumes in its original base configuration with a single plurality of reels and a single array (FIG. 3).

Referring to FIG. 6, in response to a second triggering symbol combination during Level One play, for example, a designated three-high stack in either the base array 210 or the second array 250, a second “level up” action to Level Two is initiated.

At Level Two, a third plurality of symbol bearing reels and third array 260 are added to the game and additional spins are added to the spin counter. In accordance with some embodiments, the number of additional spins equals the number of spins that occurred in the previous level, in essence, the spin counter is reset to its original value. In other embodiments, the number of spins is a predetermined or random number of spins. As in the initiation of Level One, the symbols forming the second triggering combination are at least partially removed from the reels and replaced with a mix of symbols including enhanced payment symbols, for example, PIG symbols. In some embodiments, all occurrences on the reels of the symbols forming the second triggering combination are removed and replaced,

The pluralities of reels are repeatedly spun and stopped to land symbols in their respective arrays. The spin counter is decremented following each spin. If no spins remain, the Level Up mode is terminated and the game resumes in its original base configuration with a single plurality of reels and a single array (FIG. 3).

In response to the landed symbols including a third triggering symbol combination, for example, a designated three-high stack in either the base array 210, the second array 250, or the third array 260, a third “level up” action to Level Three is initiated.

At Level Three, the base array 210, the second array 240 and the third array 250 are removed and eight new pluralities of reels and eight new arrays 271-278 are added to the game. The symbols forming the third triggering combination are at least partially removed from the reels and replaced as above. Additional spins are added to the spin counter as described above. The pluralities of reels are repeatedly spun and stopped to land symbols in their respective arrays. The spin counter is decremented following each spin. If no spins remain, the Level Up mode is terminated and the game resumes in its original base configuration with a single plurality of reels and a single array (FIG. 3).

Otherwise, in response to the landed symbols including a fourth triggering symbol combination, a special award is paid (such as a Grand Progressive award) and the “Level Up” mode is terminated.

Spins in the base game, Level 1, Level 2 and Level 3 are all initiated in response to a wager. In accordance with alternates embodiments, one or more of the levels may be played as free spins.

Randomly, a “Sticky Pig” feature may be triggered in Level One, Level Two or Level Three. In this feature, a random number of spins are free. PIG symbols in the arrays when the feature is triggered are held in place and not replaced for the duration of the free spins.

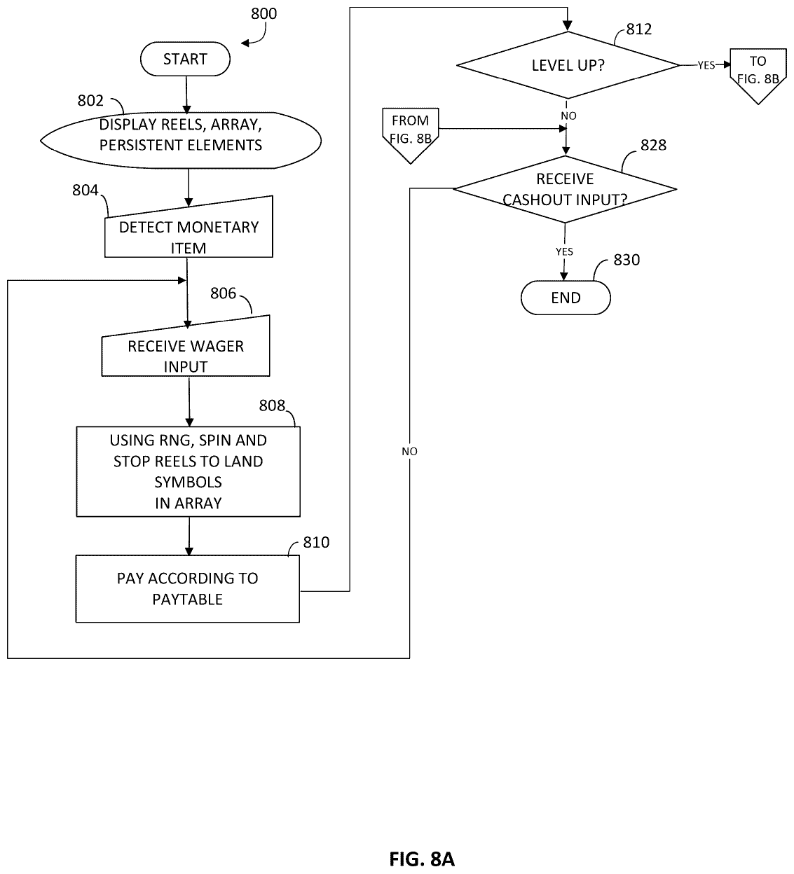

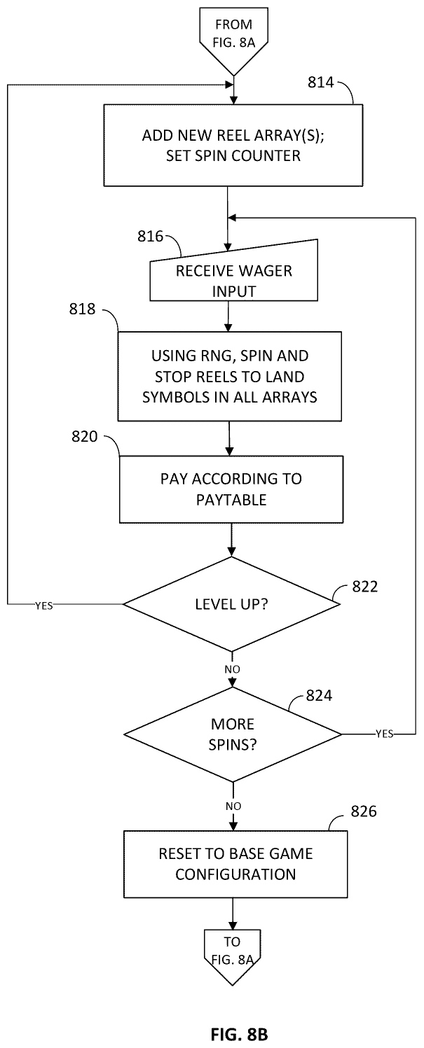

Referring now to FIGS. 8A and 8B, there is shown a flow diagram representing one data processing method corresponding to at least some instructions stored and executed by the game-logic circuitry 40 in FIG. 2 to perform operations according to embodiments of the present invention. The data processing method is described below in connection with the exemplary presentations of different spin outcomes described above in FIGS. 3-7.

### Game Play Initiation

Referring to FIG. 8A, the data processing method commences at step 800. At step 802, the game-logic circuitry controls one or more presentation devices (e.g., mechanical-reel display device, video display device, or a combination thereof) to present a plurality of symbol-bearing reels, an array of symbol positions, and a plurality of persistent elements.

At step 804, the game-logic circuitry detects, via a value input device, a physical item associated with a monetary value that establishes a monetary balance in the form of cash or credits. The monetary balance may be shown on a meter 200 (FIG. 3).

### Base Game Spin

At step 806, the game-logic circuitry initiates a base game of a wagering game cycle (i.e., spin cycle) in response to an input indicative of a wager covered by the monetary balance. To initiate a spin of the reels, the player may press a “Spin” or “Max Bet” key on a button panel or touch screen. The wager may be shown on a bet meter 202 (FIG. 3).

At step 808, using an RNG, the game-logic circuitry spins and stops the reels to randomly land symbols from the reels in the array in visual association with one or ways. The reel spin may be animated on a video display by depicting symbol-bearing strips moving vertically across the display and synchronously updating the symbols visible on each strip as the strip moves across the display. FIG. 3 depicts an example of a base-game spin outcome.

### Base Game Win Evaluation

At step 810, the game-logic circuitry evaluates the patterns of symbols landed in the array. Payouts are awarded in accordance with a pay table. The pay table may, for example, include “ways pays,” “line pays” and “scatter pays,” all well-known to those skilled in the art. The non-limiting examples herein assume a pay table based on ways pays. Briefly, ways pays appear on adjacent reels without the requirement to be on a specified pay line or directly adjacent to one another. For example, a three by five symbol array has 243 (i.e., 35) ways to win. In a 243 ways slot machine, any combination of three or more matching symbols can be a win, provided they appear anywhere on adjacent reels, starting from the first reel and going left to right. Only one instance of a symbol on a reel is included in a given winning combination. Thus, the best combination is a five of a kind. However, each winning combination is multiplied by the number of ways it occurs from left to right, so it is advantageous to have more than one instance of a given symbol on a reel.

In the example shown here, a multiplier may also appear on PIG symbols, and affect the number of ways. (A PIG x2 represents “a stack of two PIGS”.)

| | | | | |
|---|---|---|---|---|
| | | | | Pig |
| Pig | Pig | Pig | Pig ×2 | |
| | Pig ×2 | | | |

In the example above, the result is 1 way on reel 1, 2+1=3 ways on reel 2, 1 way on reel 3, 2 ways on reel 4, and 1 way on reel 5. The ways on each of the reels is then summed. Total ways to get a PIG Five of a Kind=1×3×1×2×1=6 ways. If a single PIG Five-of-a-Kind pays 200 credits, according to the pay table, the resulting pay in this example would be 6 Ways×200 Credits=1200 Credits.

To animate a winning combination, the display may apply a border, pattern, color change, background change, watermark, or other distinguishing characteristic to the winning winning symbols that contributed to the pay. The awarded pay is added to a win meter 204 (FIG. 3).

### Entering Level Up Mode

At step 812, the game-logic circuitry determines whether or not a level up triggering condition occurred, as described above with reference to FIG. 5. If not, flow continues at step 828, otherwise flow continues to step 814 on FIG. 8B.

At step 814, a new level (Level One, Level Two or Level Three) is initiated, as described above with respect to FIG. 5, FIG. 6 and FIG. 7, respectively. The game-logic circuitry may enhance the leveling up and introduction of new pluralities of reels and arrays with complex animations via the one or more presentation devices. The triggering symbols, for example, symbols belonging to a three-high stack, are at least partially removed from the reels and replaced with a mix of symbols including more special symbols (i.e., PIG symbols) to make the game more lucrative to the player. In some embodiments, all occurrences of the triggering symbols on the reels are removed and replaced by other symbols. The spin counter is initialized or modified as described above, depending on which level is being initiated.

In accordance with one or more embodiments, the replacement of the triggering symbols on the reels and the gradual enhancement of the reels with increasingly more special (PIG) symbols is accomplished by having a reel set with a different reel strip symbol layout for each level, each with a higher proportion of PIG or other higher paying symbols.

The reel sets may also have “mystery” symbol locations that are initially populated by the triggering symbols. Upgrading to a new symbol set upon leveling up involves replacing these mystery symbols with non-triggering symbols. For example, in the current game example, at the base game level, the reel strip layout includes MYST_1, MYST_2, MYST_3, and MYST_4 symbols; each of them can be populated by one of four triggering symbols (one for each Level Up possibility). However, at Level One, the replacement reel sets for each array only contain MYST_1, MYST_2 and MYST_3 symbols in their reel strip layouts. These are populated with the three triggering symbols that did not contribute to the leveling up to Level One. The same approach is used for the remaining levels, with the reel sets for Level Two containing only MYST_1 and MYST_2 symbols to be populated with the triggering symbols that did not contribute to the prior leveling up actions. The process continues for all subsequent remaining levels. In this way, occurrences of the triggering symbols from lower levels are removed from the reels and the new reel sets contain other symbols in their place instead. Typically, the higher the level, the higher the proportion of better paying symbols (i.e, PIG symbols or other higher paying symbols).

In some embodiments, the number of mystery symbol types are not reduced at each level, rather, the triggering symbols they represented at the previous level are simply replaced by non-triggering symbols until, for example, all MYST symbols have been replaced by non-triggering symbols. In this example, all reel strip layouts at all levels contain MYST_1, MYST_2, MYST_3 and MYST_4 symbols, populated with a mix of triggering and non-triggering symbols. Any approach that achieves the goal of removing triggering symbols from previous levels and enhancing the reel strip layouts at each new level falls within the spirit and scope of the invention.

At step 816, as at step 806, a wager is accepted to initiate the next spin.

At step 818, using the RNG, the game-logic circuitry performs a spin by spinning and stopping the reels to randomly land symbols from all of the pluralities of reels in their respective arrays as described above with respect to step 808.

At step 820, the game-logic circuitry evaluates the landed combination of symbols in each of the arrays as described above with respect to step 810. In the preferred embodiments, the paytable applied to each array is the same. In alternate embodiments, each array may have its own paytable. For example, the base array 210 may be evaluated according to a first paytable and the arrays (250, 260, etc.) of other levels may be evaluated according to one or more other paytables.

At step 822, the evaluation of the landed combinations of symbols on each of the arrays may include the detection of a new leveling up triggering condition. If no triggering condition exists, flow continues to step 824. Otherwise, flow returns to step 814 for the introduction of a new level.

At step 824, the spin counter is decremented and a determination made whether additional spins remain. If so, flow returns to step 816, otherwise, Level Up mode is terminated and the game is reset to the base game configuration (FIG. 3) at step 826, after which flow returns to step 828 of FIG. 8A.

At step 828, the game-logic circuitry determines whether or not it has received a cashout input via at least one of the one or more player input devices of the gaming machine. If it has not received a cashout input, the game-logic circuitry waits for the next wager input at step 806. If it has received a cashout input, the game-logic circuitry initiates a payout from the monetary balance on the meter 200. The data processing method then ends at step 830.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

In this description, numerous specific details are set forth. However, it is understood that embodiments of the invention may be practiced without these specific details.

Variations falling within the scope of the invention may include, as shown, the introduction or replacement of various numbers of arrays from the game. While all of the arrays described above have the same 3×5 configuration, the array(s) associated with each level may vary.

In accordance with some embodiments, the symbols that replace occurrences of triggering symbols on the reels may introduce new symbols to the reels. In these cases, a new paytable including the new symbols is also introduced.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting, by a presentation assembly, a meter, a base array and a plurality of symbol-bearing base reels in an original presentation;
conducting, by game-logic circuitry, a base game spin of the base reels to land symbols from the base reels in the base array;
incrementing, by the game-logic circuitry, the meter for each winning combination of landed symbols according to a first paytable; and
recursively in response to the landed symbols including a triggering combination of landed symbols:
initiating a new level of the game comprising animating, by the presentation assembly, an addition of at least one more array and associated plurality of symbol bearing reels;
establishing a spin counter for the new level;
for each occurrence on the reels of the symbol that formed the triggering combination, replacing the triggering symbol with a replacement symbol;
conducting one of more additional spins of all the pluralities of reels to land newly landed symbols from the reels in their respective arrays;
incrementing, by the game-logic circuitry, the meter for each winning combination of newly landed symbols according to a second paytable; and
concluding the recursion when the spin counter is exhausted or in response to a predetermined terminating event; and
restoring the base array and plurality of symbol-bearing base reels to the original presentation.

2. The method of claim 1, wherein the first paytable and the second paytable are the same.

3. The method of claim 1, wherein the first paytable and the second paytable are different.

4. The method of claim 1, wherein at least one of the paytables includes ways pays.

5. The method of claim 1, wherein establishing the spin counter for the new level comprises initializing the spin counter.

6. The method of claim 1, wherein establishing the spin counter for the new level comprises resetting the spin counter.

7. The method of claim 1, wherein the terminating event comprises a predetermined winning combination.

8. The method of claim 7, wherein the predetermined winning combination awards a progressive award.

9. The method of claim 1, wherein the replacement symbol bears a multiplier.

10. The method of claim 1, wherein the base array and the at least one more array comprise the same number of rows and columns.

11. A gaming machine comprising:
a presentation assembly; and
game-logic circuitry configured to perform the operations of:
presenting, by a presentation assembly, a meter, a base array and a plurality of symbol-bearing base reels in an original presentation;
conducting a base game spin of the base reels to land symbols from the base reels in the base array;
incrementing the meter for each winning combination of landed symbols according to a first paytable; and
recursively in response to the landed symbols including a triggering combination of landed symbols:
initiating a new level of the game comprising animating, by the presentation assembly, an addition of at least one more array and associated plurality of symbol bearing reels;
establishing a spin counter for the new level;
for each occurrence on the reels of the symbol that formed the triggering combination, replacing the triggering symbol with a replacement symbol;
conducting one of more additional spins of all the pluralities of reels to land newly landed symbols from the reels in their respective arrays;
incrementing, by the game-logic circuitry, the meter for each winning combination of newly landed symbols according to a second paytable; and
concluding the recursion when the spin counter is exhausted or in response to a predetermined terminating event; and
restoring the base array and plurality of symbol-bearing base reels to the original presentation.

12. The gaming machine of claim 11, wherein the first paytable and the second paytable are the same.

13. The gaming machine of claim 11, wherein the first paytable and the second paytable are different.

14. The gaming machine of claim 11, wherein at least one of the paytables includes ways pays.

15. The gaming machine of claim 11, wherein establishing the spin counter for the new level comprises initializing the spin counter.

16. The gaming machine of claim 11, wherein establishing the spin counter for the new level comprises resetting the spin counter.

17. The gaming machine of claim 11, wherein the terminating event comprises a predetermined winning combination.

18. The gaming machine of claim 17, wherein the predetermined winning combination is awards a progressive award.

19. The gaming machine of claim 11, wherein the replacement symbol bears a multiplier.

20. The gaming machine of claim 11, wherein the base array and the at least one more array comprise the same number of rows and columns.
